(19) United States
(12) Patent Application Publication
(10) Pub. No.: US 2014/0009511 A1
(43) Pub. Date: Jan. 9, 2014

(54) POWER SELECTOR, SOURCE DRIVER AND OPERATING METHOD THEREOF

(71) Applicant: Novatek Microelectronics Corp., Hsinchu (TW)

(72) Inventor: Sheng-Wen Hsiao, Changhua County (TW)

(21) Appl. No.: 13/923,379

(22) Filed: Jun. 21, 2013

(30) Foreign Application Priority Data
Jul. 4, 2012 (TW) 101124065

(51) Int. Cl. G09G 3/36

(52) U.S. Cl. CPC G09G 3/3614
USPC 345/690; 345/89

(57) ABSTRACT

A power selector, a source driver and an operating method thereof are provided. The source driver includes a plurality of channel groups. Each channel group includes a first and a second switching unit, a first and a second multiplexer, and an operating voltage control module. The first and the second switching unit respectively receive a first-polarity grayscale data and a second-polarity grayscale data. Output terminals of the first and the second multiplexer are respectively coupled to a first and a second data line. The operating voltage control module switches operating voltages of the first and the second multiplexer to a first operating power set or a second operating power set according to polarities of the first and the second data line and controls the first and the second switching unit to prevent the first and the second multiplexer from receiving the first-polarity grayscale data and the second-polarity grayscale data simultaneously.

### CROSS-REFERENCE TO RELATED APPLICATION

This application claims the priority benefit of Taiwan application serial no. 101124065, filed on Jul. 4, 2012. The entirety of the above-mentioned patent application is hereby incorporated by reference herein and made a part of this specification.

### BACKGROUND OF THE INVENTION

1. Field of the Invention

The invention generally relates to a display device, and more particularly, to a power selector that can adopt devices with low withstand voltages, a source driver and an operating method thereof.

2. Description of Related Art

When a liquid crystal display (LCD) displays images, due to the characteristic of liquid crystal, positive and negative grayscale voltages need to be frequently and alternatively supplied to each liquid crystal molecule to invert the polarity of the liquid crystal molecule and display the desired grayscale data. Thereby, the liquid crystal molecules won't remain at a specific voltage for a long time or, as a result, stop rotating in response to electric field variations. Meanwhile, the display quality of the LCD is improved.

Accordingly, a driving circuit supplying grayscale voltages to liquid crystal molecules needs to support an operating voltage range from positive grayscale voltage to negative grayscale voltage. Compared to other circuits, a driving circuit for polarity inversion purpose requires a wider operating voltage range. Besides, the equivalent turn-on impedance produced when the driving circuit drives liquid crystal molecules is relatively high. As a result, power is unnecessarily consumed. Moreover, devices with high withstand voltages need to be used in the driving circuit described above. As a result, the manufacturing cost of the driving circuit is high.

### SUMMARY OF THE INVENTION

Accordingly, the invention is directed to a power selector, a source driver and an operating method thereof, in which the operating power sets of multiplexers connected to data lines are dynamically switched at the time of polarity inversion, so that the multiplexers can transmit grayscale voltages of different polarities at different time points. Thereby, the multiplexers can adopt devices with low withstand voltages, and the equivalent turn-on impedance produced while driving liquid crystal molecules can be reduced.

The invention provides a source driver. The source drive includes a plurality of channel groups. Each of the channel groups includes a first switching unit, a second switching unit, a first multiplexer, a second multiplexer, and an operating voltage control module. The first switching unit receives a first-polarity grayscale data, and the second switching unit receives a second-polarity grayscale data. The first multiplexer is coupled to the first switching unit and the second switching unit, and an output terminal of the first multiplexer is coupled to a first data line. The second multiplexer is coupled to the first switching unit and the second switching unit, and an output terminal of the second multiplexer is coupled to a second data line. The operating voltage control module is coupled to the first switching unit, the second switching unit, the first multiplexer, and the second multiplexer. The operating voltage control module switches operating voltages of the first multiplexer and the second multiplexer to a first operating power set or a second operating power set according to polarities of the first data line and the second data line and controls the first switching unit and the second switching unit to prevent the first multiplexer and the second multiplexer from receiving the first-polarity grayscale data and the second-polarity grayscale data at the same time.

According to an embodiment of the invention, the first operating power set includes a first-polarity operating voltage and a first-polarity ground voltage. The voltage level of the first-polarity grayscale data is between the first-polarity operating voltage and the first-polarity ground voltage. The second operating power set includes a second-polarity operating voltage and a second-polarity ground voltage. The voltage level of the second-polarity grayscale data is between the second-polarity operating voltage and the second-polarity ground voltage.

The invention provides an operating method of a source driver. The operating method is adapted to a plurality of channel groups of the source driver. Each of the channel groups includes a first switching unit, a second switching unit, a first multiplexer, and a second multiplexer. The operating method includes following steps. A first-polarity grayscale data and a second-polarity grayscale data are respectively received by the first switching unit and the second switching unit. Operating voltages of the first multiplexer and the second multiplexer are switched to a first operating power set or a second operating power set according to polarities of a first data line and a second data line. Herein output terminals of the first multiplexer and the second multiplexer are respectively coupled to the first data line and the second data line. The first switching unit and the second switching unit are controlled according to the polarities of the first data line and the second data line, so as to prevent the first multiplexer and the second multiplexer from receiving the first-polarity grayscale data and the second-polarity grayscale data at the same time.

Other implementation details of the source driver operating method can be referred to foregoing description and will not be described herein.

The invention further provides a power selector including a first switching unit, a second switching unit, a first multiplexer, a second multiplexer, an operating voltage control module, and a data control module. The first switching unit receives a first data. The second switching unit receives a second data. The first multiplexer is coupled to the first switching unit and the second switching unit, and an output terminal of the first multiplexer is coupled to a first data line. The second multiplexer is coupled to the first switching unit and the second switching unit, and an output terminal of the second multiplexer is coupled to a second data line. The operating voltage control module is coupled to the first multiplexer and the second multiplexer. The operating voltage control module dynamically switches operating voltages of the first multiplexer and the second multiplexer according to an output voltage range of the first multiplexer and the second multiplexer. The data control module is coupled to the first switching unit and the second switching unit. The data control module controls the first switching unit and the second switching unit to prevent the first multiplexer and the second multiplexer from receiving the first data and the second data at the same time.

Other implementation details of the power selector can be referred to foregoing description and will not be described herein.

As described above, in a power selector, a source driver and an operating method thereof provided by embodiments of the invention, the operating power sets of multiplexers coupled to data lines are switched according to the polarities of the data lines or the variations of data voltages at the time of polarity inversion of liquid crystal molecules, so as to dynamically change the operating voltage range of the multiplexers. Thereby, the multiplexers can adopt devices with relatively low withstand voltages. Accordingly, the manufacturing cost of the source driver is reduced. Besides, the equivalent turn-on impedance produced while driving the liquid crystal molecules is reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a channel group in a liquid crystal display (LCD) according to an embodiment of the invention.

FIG. 2 and FIG. 3 are respectively diagrams illustrating how a channel group supplies grayscale data of different polarities according to an embodiment of the invention.

FIG. 4 illustrates waveforms of a polarity control signal PCS, an operating voltage terminal VN1, a ground voltage terminal GN1, an operating voltage terminal VN2, a ground voltage terminal GN2, and data lines Sout[N] and Sout[N+1] according to an embodiment of the invention.

FIG. 5 is a flowchart of an operating method of a source driver according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Due to the characteristic of liquid crystal, the polarity of each liquid crystal molecule needs to be frequently inverted to drive the liquid crystal molecule to display desired grayscale data. Accordingly, many polarity inversion modes, such as the column inversion mode and the dot inversion mode, have been developed. A source driver is usually connected to a plurality of data lines on a liquid crystal display (LCD) panel through a multiplexer or a source buffer pair, and each data line is corresponding to a column or a row of pixel units. The source driver transmits corresponding grayscale data to the pixel units to display images.

However, because the part of the source driving circuit with the polarity inversion capability (for example, the multiplexer or the source buffer pair) needs to support a tolerance range between positive grayscale voltage and negative grayscale voltage, the equivalent turn-on impedance produced when the source driving circuit drives the liquid crystal molecules is relative high. As a result, power is unnecessarily consumed. In addition, the manufacturing cost of the source driver which has to adopt devices with high withstand voltages is high. Thereby, in a source driver provided by an embodiment of the invention, the operating power range of a multiplexer or a source buffer pair is dynamically switched at the time of polarity inversion, so that grayscale voltages of different polarities can be supplied at different time points without adopting any device of high withstand voltage. In other words, the source driver disclosed in the present embodiment can dynamically adjust the operating voltage range of the source buffer pair according to the voltages supplied for polarity inversion. Accordingly, the source driver can adopt devices with relatively low withstand voltages and the equivalent turn-on impedance produced while driving the liquid crystal molecules is reduced. On the other hand, since devices with low withstand voltages are low-cost, the manufacturing cost of the source driver is reduced.

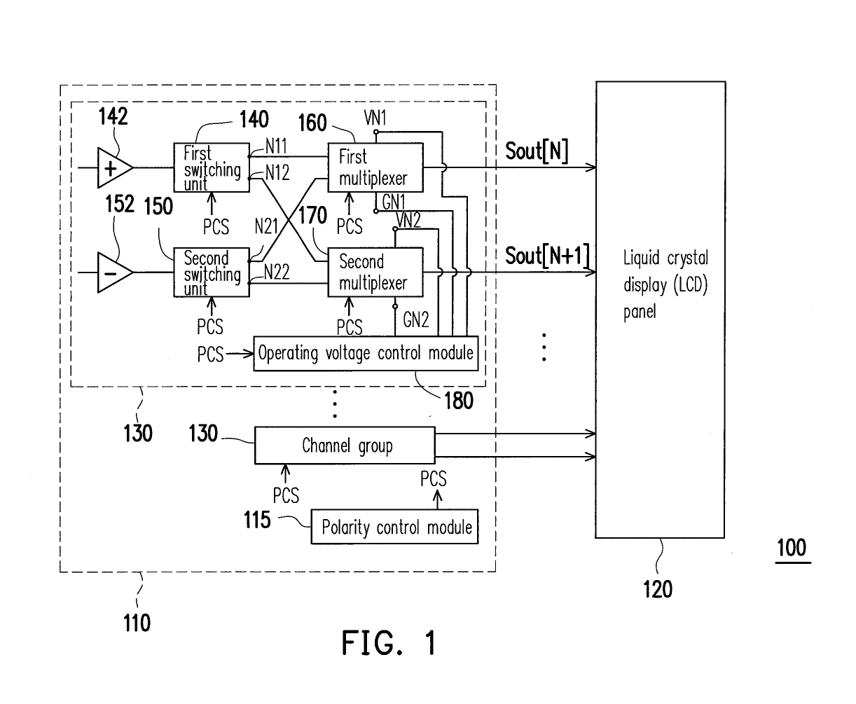

FIG. 1 is a block diagram of a channel group 130 in a LCD 100 according to an embodiment of the invention. Referring to FIG. 1, the LCD 100 includes a source driver 110 and a LCD panel 120. The LCD panel 120 includes a plurality of pixel units arranged into an array. Each pixel unit is coupled to a plurality of scan lines and a plurality of data lines (for example, data lines Sout[N]-Sout[N+1]). The source driver 110 includes a plurality of channel groups 130 and a polarity control module 115. The channel groups 130 respectively drive the pixel units on each data line during different scan periods. The polarity control module 115 determines dot inversion time according to a related control signal in received image information and controls the channel groups 130 through a polarity control signal PCS to alternatively output grayscale data of different polarities on two adjacent data lines.

The LCD 100 sequentially enables the scan lines and controls grayscale data transmitted by the source driver 110 through the data lines to the pixel units on the enabled scan line to display image. Each channel group of a source driver may include a shift register (SR), a digital-to-analog converter (DAC), an output buffer, and a source buffer pair based on the polarity inversion mode of the source driver. The operations of aforementioned devices in the source driver should be understood very well by those having ordinary knowledge in the art therefore will not be described in detail herein.

Each channel group 130 has a first switching unit 140, a second switching unit 150, a first multiplexer 160, a second multiplexer 170, and an operating voltage control module 180. Herein it is assumed that the first polarity is the positive polarity, the second polarity is the negative polarity, and the source driver 110 works in the dot inversion mode. Accordingly, the first switching unit 140 and the first buffer 142 are respectively referred to as a positive switching unit 140 and a positive buffer 142, and the second switching unit 150 and the second buffer 152 are respectively referred to as a negative switching unit 150 and a negative buffer 152. The positive switching unit 140 receives an analog grayscale voltage of a specific polarity (the positive polarity) converted by the DAC through the positive buffer 142. Similarly, the negative switching unit 150 receives a negative analog grayscale voltage through the negative buffer 152. The control terminals of the first switching unit 140 and the second switching unit 150 receive the polarity control signal PCS from the polarity control module 115. In the present embodiment, the first switching unit 140 and the second switching unit 150 are implemented with 2:1 de-multiplexers, and the first multiplexer 160 and the second multiplexer 170 are implemented with 1:2 multiplexers.

The first input terminal and the second input terminal of the first multiplexer 160 are respectively coupled to the first output terminal N11 of the first switching unit 140 and the first output terminal N21 of the second switching unit 150. The first input terminal and the second input terminal of the second multiplexer 170 are respectively coupled to the second output terminal N12 of the first switching unit 140 and the second output terminal N22 of the second switching unit 150. The output terminal of the first multiplexer 160 is coupled to the first data line Sout[N], and the output terminal of the second multiplexer 170 is coupled to the second data line Sout[N+1]. The output terminals of the first multiplexer 160 and the second multiplexer 170 receive the polarity control signal PCS to be controlled by the polarity control module 115. In the present embodiment, the first buffer 142, the second buffer 152, the first switching unit 140, the second switching unit 150, the first multiplexer 160, and the second multiplexer 170 are generally referred to as a source buffer pair. The first data line Sout[N] and the second data line Sout[N+1] are two data lines corresponding to adjacent scan lines.

In the present embodiment, the polarity control module 115 couples and controls various components (especially the switching units 140 and 150 and the multiplexers 160 and 170) of each source buffer pair in each channel group 130 through the polarity control signal PCS, so as to control the positive grayscale data and the negative grayscale data to be alternatively output through the data lines Sout[N] and Sout[N+1].

It should be mentioned herein that an operating voltage terminal VN1 and a ground voltage terminal GN1 of the first multiplexer 160 and an operating voltage terminal VN2 and a ground voltage terminal GN2 of the second multiplexer 170 are controlled by the operating voltage control module 180. In the present embodiment, the operating voltage terminals VN1 and VN2 and the ground voltage terminals GN1 and GN2 are coupled to the operating voltage control module 180. Thus, the operating voltage control module 180 can dynamically switch the operating voltages of the first multiplexer 160 and the second multiplexer 170 to a first operating power set or a second operating power set according to the polarities of the first data line Sout[N] and the second data line Sout[N+1] (i.e., according to the polarity control signal PCS). Besides, the polarity control module 115 controls the first switching unit 140 and the second switching unit 150 to prevent the first multiplexer 160 and the second multiplexer 170 from receiving a first-polarity grayscale data (i.e., a positive grayscale data) and a second-polarity grayscale data (i.e., a negative grayscale data) at the same time.

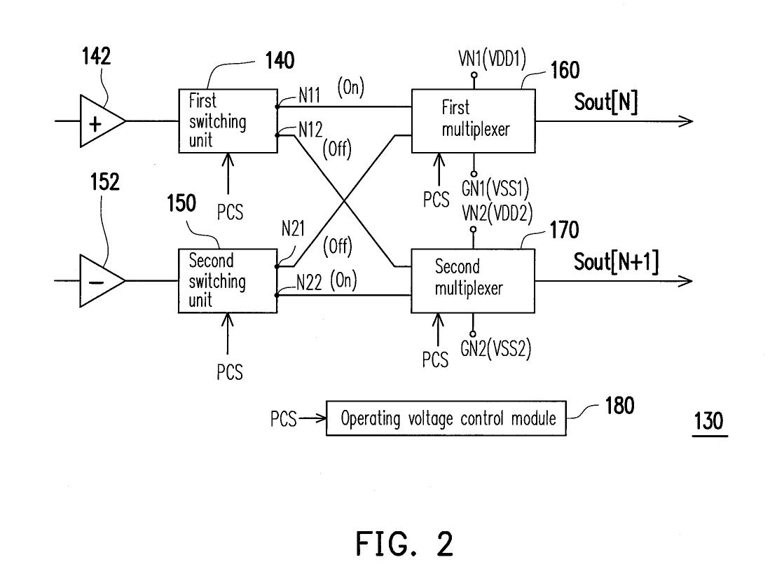

Below, the embodiment illustrated in FIG. 2 will be described with reference to an example. Herein it is assumed that the voltage of the first-polarity grayscale data (i.e., the positive grayscale data) provided by the positive buffer 142 is between 6V and 0V (GND), and the voltage of the second-polarity grayscale data (i.e., the negative grayscale data) provided by the negative buffer 152 is between 0V (GND) and −6V. Aforementioned first operating power set includes a first-polarity operating voltage VDD1 (for example, 6V) and a first-polarity ground voltage VSS1 (for example, 0V). Thus, the voltage level of the first-polarity grayscale data is between the first-polarity operating voltage VDD1 (6V) and the first-polarity ground voltage VSS1 (0V). Similarly, aforementioned second operating power set includes a second-polarity operating voltage VDD2 (for example, 0V) and a second-polarity ground voltage VSS2 (for example, −6V). Thus, the voltage level of the second-polarity grayscale data is between the second-polarity operating voltage VDD2 (0V) and the second-polarity ground voltage VSS2 (−6V).

In a general source driver operating technique, in order to allow the multiplexers 160 and 170 to output positive and negative grayscale data, the withstand voltage range of the multiplexers 160 and 170 has to include the voltage levels of aforementioned grayscale data. Thus, the multiplexers 160 and 170 need to be implemented by using devices with high withstand voltages (for example, devices having a withstand voltage range of 6V-−6V). Namely, if the withstand voltage range of the multiplexers 160 and 170 is simply 6V-0V or 0V-−6V, devices in the multiplexers 160 and 170 will be damaged by any voltage exceeding the withstand voltage range thereof.

In the present embodiment, the operating voltage control module 180 in each channel group 130 dynamically switches the operating voltages of the multiplexers 160 and 170 and the voltages of related control signals at the time of dot inversion according to the polarities of the data lines. Thus, the multiplexers 160 and 170 in the present embodiment can be implemented by using devices with moderate withstand voltages (i.e., the widest withstand voltage range of the devices is 6V-0V or 0V-−6V). Herein the devices for implementing the multiplexers 160 and 170 won't be damaged as when a general source driver operating technique is adopted, and the equivalent turn-on impedance produced when the liquid crystal molecules are driven is reduced.

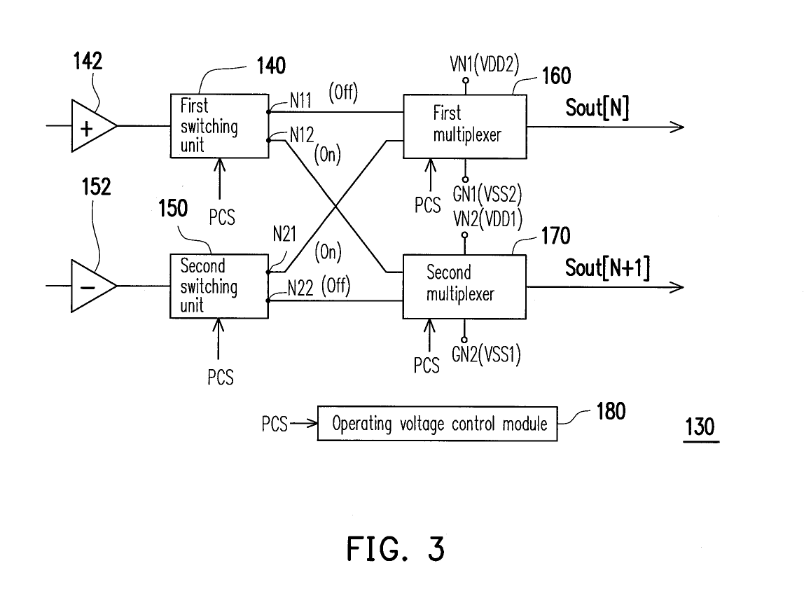

FIG. 2 and FIG. 3 are respectively diagrams illustrating how a channel group 130 supplies grayscale data of different polarities according to an embodiment of the invention. For the convenience of description, in FIG. 2 and FIG. 3, only one channel group 130 in the source driver 110 (illustrated in FIG. 1) is illustrated, and the connections between the operating voltage control module 180 and the operating voltage terminals VN1 and VN2 and the ground voltage terminals GN1 and GN2 are omitted. Instead, in FIG. 2 and FIG. 3, the operating voltages of the operating voltage terminals VN1 and VN2 and the ground voltage terminals GN1 and GN2 are denoted in the brackets that follow, so as to indicate that the operating voltage control module 180 adjusts the voltages on aforementioned terminals to the corresponding operating voltages in the brackets.

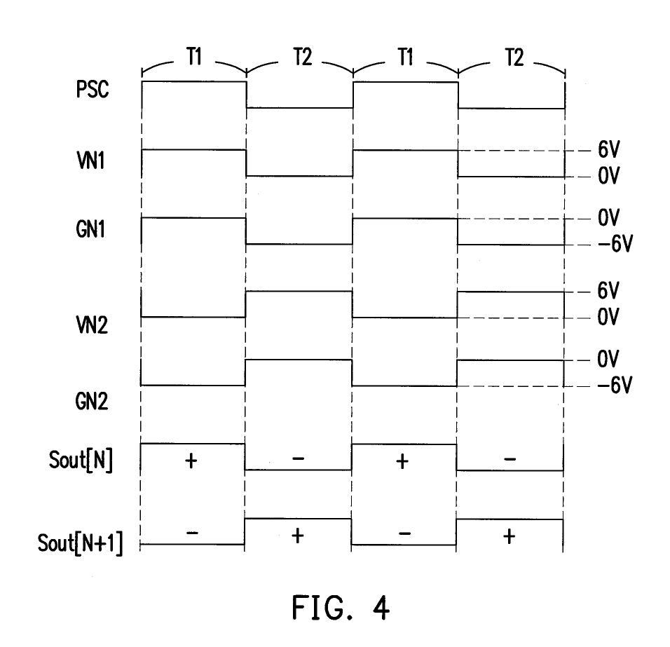

FIG. 4 illustrates the waveforms of the polarity control signal PCS, the operating voltage terminal VN1, the ground voltage terminal GN1, the operating voltage terminal VN2, the ground voltage terminal GN2, and the data lines Sout[N] and Sout[N+1] according to an embodiment of the invention. Referring to both FIG. 2 and FIG. 4, when the polarity control signal PCS is enabled (i.e., during the period T1), the grayscale data on the first data line Sout[N] is in the first polarity (i.e., the positive polarity), and the grayscale data on the second data line Sout[N+1] is in the second polarity (i.e., the negative polarity). Thus, the operating voltage control module 180 switches the operating voltage of the first multiplexer 160 to the first operating power set and switches the operating voltage of the second multiplexer 170 to the second operating power set. Namely, the operating voltage control module 180 adjusts the voltages on the operating voltage terminal VN1 and the ground voltage terminal GN1 of the first multiplexer 160 respectively to the first-polarity operating voltage VDD1 (6V) and the first-polarity ground voltage VSS1 (0V) and adjusts the voltages on the operating voltage terminal VN2 and the ground voltage terminal GN2 of the second multiplexer 170 respectively to the second-polarity operating voltage VDD2 (0V) and the second-polarity ground voltage VSS2 (−6V).

When the polarity control signal PCS is enabled (during the period T1), it is turned on between the first output terminal N11 of the first switching unit 140 and the first input terminal of the first multiplexer 160 and between the first output terminal N21 of the second switching unit 150 and the second input terminal of the second multiplexer 170, and it is turned off between the second output terminal N12 of the first switching unit 140 and the first input terminal of the second multiplexer 170 and between the second output terminal N22 of the second switching unit 150 and the second input terminal of the first multiplexer 160. The positive grayscale data is transmitted to the first data line Sout[N] through the first switching unit 140 and the first multiplexer 160 (denoted with the symbol “+” in FIG. 4), and the negative grayscale data is transmitted to the second data line Sout[N+1] through the second switching unit 150 and the second multiplexer 170 (denoted with the symbol “−” in FIG. 4). Thus, the polarity control module 115 can prevent the first multiplexer 160 and the second multiplexer 170 from receiving the positive grayscale data and the negative grayscale data at the same time by using the polarity control signal PCS.

On the other hand, when the polarity control signal PCS is disabled (i.e., during the period T2), the grayscale data on the first data line Sout[N] is in the second polarity (i.e., the negative polarity), and the grayscale data on the second data line Sout[N+1] is in the first polarity (i.e., the positive polarity). Thus, the operating voltage control module 180 switches the operating voltage of the first multiplexer 160 to the second operating power set and switches the operating voltage of the second multiplexer 170 to the first operating power set. Namely, the operating voltage control module 180 adjusts the voltages on the operating voltage terminal VN1 and the ground voltage terminal GN1 of the first multiplexer 160 respectively to the second-polarity operating voltage VDD2 (0V) and the second-polarity ground voltage VSS2 (−6V) and adjusts the voltages on the operating voltage terminal VN2 and the ground voltage terminal GN2 of the second multiplexer 170 respectively to the first-polarity operating voltage VDD1 (6V) and the first-polarity ground voltage VSS1 (0V).

When the polarity control signal PCS is disabled (during the period T2), it is turned off between the first output terminal N11 of the first switching unit 140 and the first input terminal of the first multiplexer 160 and between the first output terminal N21 of the second switching unit 150 and the second input terminal of the second multiplexer 170, and it is turned on between the second output terminal N12 of the first switching unit 140 and the first input terminal of the second multiplexer 170 and between the second output terminal N22 of the second switching unit 150 and the second input terminal of the first multiplexer 160. The positive grayscale data is transmitted to the second data line Sout[N+1] through the first switching unit 140 and the second multiplexer 170, and the negative grayscale data is transmitted to the first data line Sout[N] through the second switching unit 150 and the first multiplexer 160.

In addition, even though each of foregoing embodiments of the invention has been described by referring to a LCD, a source driver, and channel groups thereof, those implementing the embodiment may also apply the technique described above to other circuits with multiplexers and switching units. In other words, in an embodiment of the invention, a power selector may be disposed in each channel group 130 illustrated in FIG. 2. The power selector includes a first switching unit 140 for receiving a first data (for example, a first-polarity grayscale data), a second switching unit 150 for receiving a second data (for example, a second-polarity grayscale data), a first multiplexer 160, a second multiplexer 170, an operating voltage control module 180, and a data control module (for example, the polarity control module 115 in FIG. 1). The operating voltage control module 180 dynamically switches the operating voltages of the first multiplexer 160 and the second multiplexer 170 according to output voltage range of the first switching unit 140 and the second switching unit 150. The present embodiment is the same as the embodiments described above therefore will not be described in detail herein.

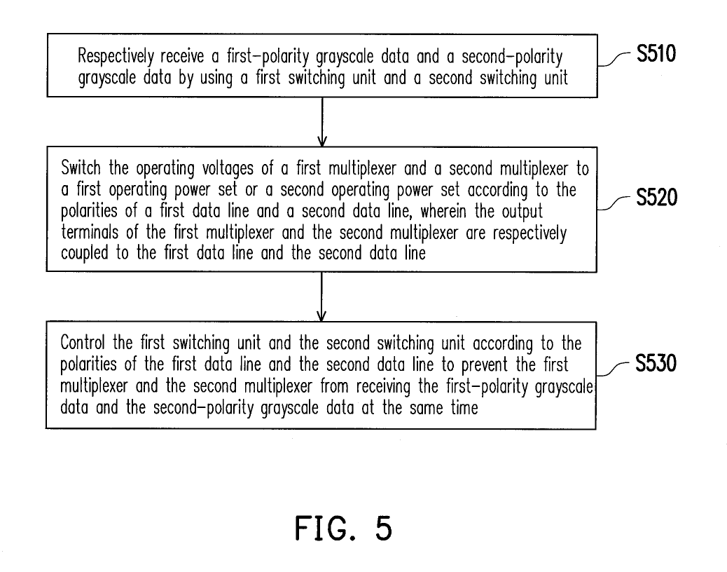

In an embodiment of the invention, a source driver operating method is provided based on foregoing descriptions. The operating method is adapted to the channel groups 130 of the source driver 110 in FIG. 1. FIG. 5 is a flowchart of an operating method of the source driver 110 according to an embodiment of the invention. Referring to both FIG. 1 and FIG. 5, in step S510, the first switching unit 140 and the second switching unit 150 respectively receive a first-polarity grayscale data and a second-polarity grayscale data. Then, in step S520, the operating voltage control module 180 switches the operating voltages of the first multiplexer 160 and the second multiplexer 170 to a first operating power set or a second operating power set according to the polarities of the first data line Sout[N] and the second data line Sout[N+1] (i.e., the polarity control signal PCS).

For example, when the first data line Sout[N] is positive and the second data line Sout[N+1] is negative, the operating voltage control module 180 switches the operating voltage of the first multiplexer 160 to the first operating power set (i.e., an operating voltage range of 6V-0V) and switches the operating voltage of the second multiplexer 170 to the second operating power set (i.e., an operating voltage range of 0V-−6V). When the first data line Sout[N] is negative and the second data line Sout[N+1] is positive, the operating voltage control module 180 switches the operating voltage of the first multiplexer 160 to the second operating power set (i.e., an operating voltage range of 0V-−6V) and switches the operating voltage of the second multiplexer 170 to the first operating power set (i.e., an operating voltage range of 6V-0V).

In step S530, the polarity control module 115 of the source driver 110 controls the first switching unit 140 and the second switching unit 150 according to the polarities of the first data line Sout[N] and the second data line Sout[N+1] to prevent the first multiplexer 160 and the second multiplexer 170 from receiving the positive grayscale data and the negative grayscale data at the same time. Other implementation details of the operating method of the source driver 110 can be referred to foregoing description and will not be described herein.

As described above, in the source driver 110 and the operating method thereof provided by embodiments of the invention, the operating power sets of the multiplexers 160 and 170 coupled to the data lines are switched according to the polarities of the data lines at the time of polarity inversion of liquid crystal molecules, so as to adjust the operating voltage range of the multiplexers 160 and 170. Thereby, the multiplexers 160 and 170 is allowed to adopt devices of relative low withstand voltages, the equivalent turn-on impedance produced when the liquid crystal molecules are driven is reduced, and the manufacturing cost of the source driver 110 is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A source driver, comprising:
a plurality of channel groups, wherein each of the channel groups comprises:
a first switching unit, receiving a first-polarity grayscale data;
a second switching unit, receiving a second-polarity grayscale data;
a first multiplexer, coupled to the first switching unit and the second switching unit, and having an output terminal coupled to a first data line;
a second multiplexer, coupled to the first switching unit and the second switching unit, and having an output terminal coupled to a second data line; and
an operating voltage control module, coupled to the first multiplexer and the second multiplexer, wherein the operating voltage control module switches operating voltages of the first multiplexer and the second multiplexer to a first operating power set or a second operating power set according to polarities of the first data line and the second data line; and
a polarity control module, coupled to the first switching unit and the second switching unit of each of the channel groups, wherein the polarity control module controls the first switching unit and the second switching unit to prevent the first multiplexer and the second multiplexer from receiving the first-polarity grayscale data and the second-polarity grayscale data at a same time.

2. The source driver according to claim 1, wherein the first operating power set comprises a first-polarity operating voltage and a first-polarity ground voltage, a voltage level of the first-polarity grayscale data is between the first-polarity operating voltage and the first-polarity ground voltage, and the second operating power set comprise a second-polarity operating voltage and a second-polarity ground voltage, and a voltage level of the second-polarity grayscale data is between the second-polarity operating voltage and the second-polarity ground voltage.

3. The source driver according to claim 1, wherein when the first data line is in a first polarity and the second data line is in a second polarity, the operating voltage control module switches the operating voltage of the first multiplexer to the first operating power set, switches the operating voltage of the second multiplexer to the second operating power set, controls the first data line to transmit the first-polarity grayscale data through the first switching unit and the first multiplexer, and controls the second data line to transmit the second-polarity grayscale data through the second switching unit and the second multiplexer.

4. The source driver according to claim 1, wherein when the first data line is in a second polarity and the second data line is in a first polarity, the operating voltage control module switches the operating voltage of the first multiplexer to the second operating power set, switches the operating voltage of the second multiplexer to the first operating power set, controls the second data line to transmit the first-polarity grayscale data through the first switching unit and the second multiplexer, and controls the second data line to transmit the first-polarity grayscale data through the second switching unit and the first multiplexer.

5. The source driver according to claim 1, wherein the first polarity is a positive polarity, and the second polarity is a negative polarity.

6. An operating method of a source driver, adapted to a plurality of channel groups of the source driver, wherein each of the channel groups comprises a first switching unit, a second switching unit, a first multiplexer, and a second multiplexer, the operating method comprising:
respectively receiving a first-polarity grayscale data and a second-polarity grayscale data by using the first switching unit and the second switching unit;
switching operating voltages of the first multiplexer and the second multiplexer to a first operating power set or a second operating power set according to a first data line and a second data line, wherein output terminals of the first multiplexer and the second multiplexer are respectively coupled to the first data line and the second data line; and
controlling the first switching unit and the second switching unit according to polarities of the first data line and the second data line to prevent the first multiplexer and the second multiplexer from receiving the first-polarity grayscale data and the second-polarity grayscale data at a same time.

7. The operating method according to claim 6, wherein the first operating power set comprises a first-polarity operating voltage and a first-polarity ground voltage, a voltage level of the first-polarity grayscale data is between the first-polarity operating voltage and the first-polarity ground voltage, and the second operating power set comprises a second-polarity operating voltage and a second-polarity ground voltage, and a voltage level of the second-polarity grayscale data is between the second-polarity operating voltage and the second-polarity ground voltage.

8. The operating method according to claim 6, wherein the step of switching the operating voltages of the first multiplexer and the second multiplexer according to the polarities of the first data line and the second data line comprises:
when the first data line is in a positive polarity and the second data line is in a negative polarity, switching the operating voltage of the first multiplexer to the first operating power set; and
switching the operating voltage of the second multiplexer to the second operating power set.

9. The operating method according to claim 8, wherein the step of preventing the first multiplexer and the second multiplexer from receiving the first-polarity grayscale data and the second-polarity grayscale data at the same time comprises:
controlling the first data line to transmit the first-polarity grayscale data through the first switching unit and the first multiplexer; and
controlling the second data line to transmit the second-polarity grayscale data through the second switching unit and the second multiplexer.

10. The operating method according to claim 6, wherein the step of switching the operating voltages of the first multiplexer and the second multiplexer according to the polarities of the first data line and the second data line comprises:
when the first data line is in a negative polarity and the second data line is in a positive polarity, switching the operating voltage of the first multiplexer to the second operating power set; and
switching the operating voltage of the second multiplexer to the first operating power set.

11. A power selector, comprising:
a first switching unit, receiving a first data;
a second switching unit, receiving a second data;
a first multiplexer, coupled to the first switching unit and the second switching unit, and having an output terminal coupled to a first data line;
a second multiplexer, coupled to the first switching unit and the second switching unit, and having an output terminal coupled to a second data line;
an operating voltage control module, coupled to the first multiplexer and the second multiplexer, wherein the operating voltage control module dynamically switches operating voltages of the first multiplexer and the second multiplexer according to an output voltage range of the first switching unit and the second switching unit; and
a data control module, coupled to the first switching unit and the second switching unit, wherein the data control module controls the first switching unit and the second switching unit to prevent the first multiplexer and the second multiplexer from receiving the first data and the second data at a same time.

12. The power selector according to claim 11, wherein the operating voltage control module determines the output voltage range of the first multiplexer and the second multiplexer according to voltage levels of the first data line and the second data line and accordingly switches the operating voltages of the first multiplexer and the second multiplexer to a first operating power set or a second operating power set.

13. The power selector according to claim 12, wherein the first operating power set comprises a first operating voltage and a first ground voltage, a voltage level of the first data is between the first operating voltage and the first ground voltage, and the second operating power set comprises a second operating voltage and a second ground voltage, and a voltage level of the second data is between the second operating voltage and the second ground voltage.
